(19) United States
(12) Patent Application Publication
(10) Pub. No.: US 2009/0103576 A1
(43) Pub. Date: Apr. 23, 2009

(54) System and Method of Providing Second Harmonic Generation (SHG) Light in a Single Pass

(76) Inventor: Martin Achtenhagen, Plano, TX (US)

Correspondence Address: SLATER & MATSIL, L.L.P., 17950 PRESTON RD, SUITE 1000, DALLAS, TX, 75252-5793, US

(21) Appl. No.: 11/873,975

(22) Filed: Oct. 17, 2007

(51) Int. Cl. H01S 3/10

(52) U.S. Cl. 372/22

(57) ABSTRACT

A system and method of providing second harmonic generation (SHG) light in a single pass. A frequency stabilized semiconductor seed laser provides a first frequency light to a fiber amplifier. A focusing optic configuration receives the amplified first frequency light and focuses the amplified first frequency light into a non-linear material. A harmonic separator separates the first frequency light from the second frequency light and an optical output structure outputs the second frequency light.

### CROSS-REFERENCE TO RELATED APPLICATIONS

This application relates to the following co-pending and commonly assigned patent application Ser. No. 11/763,248, filed Jun. 14, 2007, entitled “Method and Laser Device for Stabilized Frequency Doubling,” which application is hereby incorporated herein by reference.

### TECHNICAL FIELD

The present invention relates generally to a system and method of producing second harmonic generation light, and more particularly, a system and method for providing second harmonic generation (SHG) light in a single pass.

### BACKGROUND

A laser is an optical source that emits photons in a coherent beam. Laser light is typically a single frequency or color, and is emitted in a narrow beam. Laser action is explained by the theories of quantum mechanics and thermodynamics. Many materials have been found to have the required characteristics to form the laser gain medium needed to power a laser, and these have led to the development of many types of lasers with different characteristics suitable for different applications. A semiconductor laser is a laser in which the active medium is a semiconductor. A common type of semiconductor laser is formed from a p-n junction, a region where p-type and n-type semiconductors meet, and is powered by an injected electrical current. As in other lasers, the gain region of the semiconductor laser is surrounded by an optical cavity. An optical cavity is an arrangement of mirrors or reflectors that form a standing wave resonator for light waves. The color or frequency of the emitted light may depend on the characteristics of the gain medium.

Another method of generating a particular color is called frequency doubling. In frequency doubling, a fundamental laser frequency is introduced into a nonlinear medium, and a portion of the fundamental frequency is doubled. Frequency doubling in nonlinear material, also called second harmonic generation (SHG), is a nonlinear optical process, in which photons interacting with a nonlinear material are effectively combined to form new photons with twice the energy and, therefore, twice the frequency and half the wavelength of the initial photons.

Optical resonators are often called cavities, and the terms are often used interchangeably in optics. Use of the term cavity does not imply a vacuum or air space. A cavity, as used in optics, may be within a solid crystal or other medium. An optical cavity (or optical resonator) is an arrangement of optical components, which allows a beam of light to circulate.

In an intra-cavity SHG laser, the frequency doubling, non-linear material is within the laser cavity. In other words, the fundamental frequency feedback to the seed laser has traversed the non-linear material. The non-linear material is within the cavity of the seed laser.

One disadvantage of the prior art is that the intra-cavity SHG laser may be limited in the power of light it can emit. Therefore, expensive multi-unit systems may be needed. Further, the intra-cavity SHG laser may be driven beyond device safe power densities, causing reliability problems and early device failure.

### SUMMARY OF THE INVENTION

In accordance with an illustrative embodiment of the present invention, a system and method of providing second harmonic generation (SHG) light in a single pass is disclosed. A frequency stabilized semiconductor seed laser provides a first frequency light to a fiber amplifier. A focusing optic configuration receives the amplified first frequency light and focuses the amplified first frequency light into a non-linear material structure. A harmonic separator separates the first frequency light from the second frequency light, and an optical output structure outputs the second frequency light.

Another embodiment is a system and method of providing second harmonic generation (SHG) light in a single pass in the visible frequency range. A further embodiment is a system and method of providing second harmonic generation (SHG) light in a single pass at greater than 0.5 watts. A yet further embodiment is a system and method of providing second harmonic generation (SHG) light in a single pass at greater than 3.0 watts.

An advantage of the illustrative embodiments is the high power output second harmonic generation light.

The foregoing has outlined rather broadly the features and technical advantages of an illustrative embodiment in order that the detailed description of the invention that follows may be better understood. Additional features and advantages of an illustrative embodiment will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the illustrative embodiments as set forth in the appended claims.

### BRIEF DESCRIPTION OF THE DRAWINGS

For a more complete understanding of the illustrative embodiments, and the advantages thereof, reference is now made to the following descriptions taken in conjunction with the accompanying drawings, in which:

FIG. 1 is a top level schematic of an SHG laser system with a frequency stabilized semiconductor seed laser in accordance with an illustrative embodiment.

FIG. 2 shows three example configurations of frequency stabilized semiconductor seed lasers, such as the frequency stabilized semiconductor seed laser 102 in FIG. 1. FIG. 2a is an illustrative embodiment of a distributed Bragg reflector (DBR) frequency stabilized semiconductor seed laser. FIG. 2b is an illustrative embodiment of a Fabry-Perot with a fiber Bragg grating as a frequency stabilized semiconductor seed laser and FIG. 2c is an illustrative embodiment of a distributed feedback (DFB) frequency stabilized semiconductor seed laser.

FIG. 3 shows an example of a simple fiber amplifier.

FIG. 4 shows an example of a simple non-linear material structure.

FIG. 5 is a flow chart for providing second harmonic generation (SHG) light in the visible frequency range at greater than 0.5 watts.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that an illustrative embodiment provides many applicable inventive concepts that can be embodied in a wide variety of specific contexts. The specific embodiments discussed are merely illustrative of specific ways to make and use the invention, and do not limit the scope of the invention.

The present invention will be described with respect to illustrative embodiments in a specific context, namely a semiconductor laser system operating in the visible range of an infra-red frequency stabilized semiconductor seed laser. The invention may also be applied, however, to other frequency stabilized semiconductor seed lasers operating in other frequency ranges. Further, the illustrative embodiments describe an SHG laser system outputting at greater than 0.5 watts, however the preferable range of output is greater than 3.0 watts. Still further, the fiber amplifier and non-linear material structure may be of differing types.

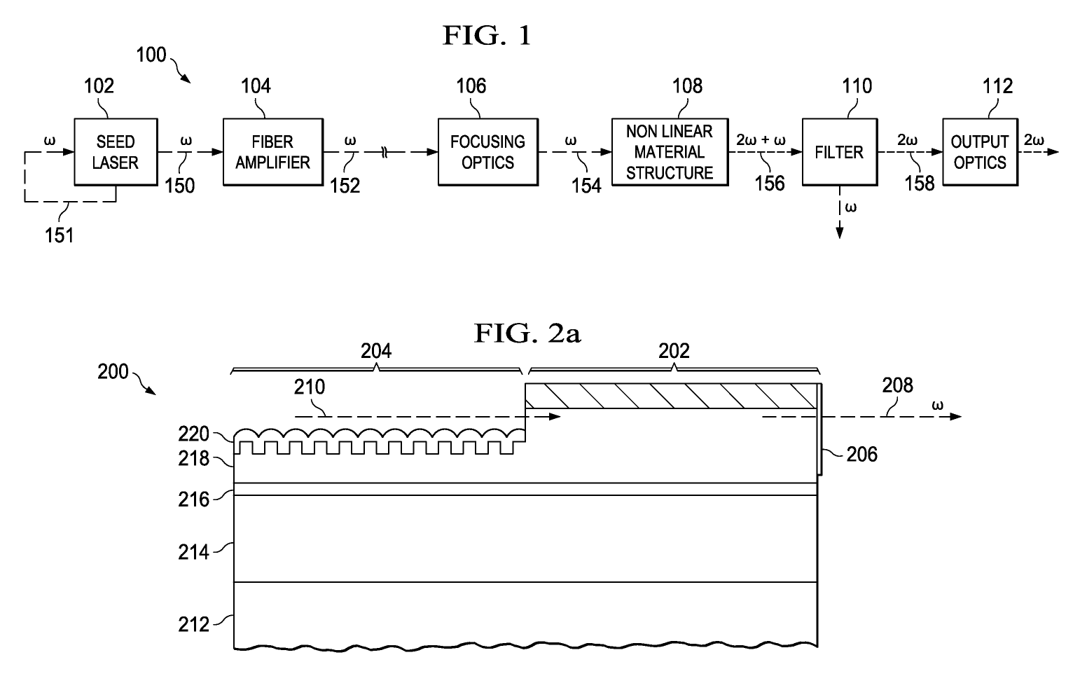

With reference now to FIG. 1, there is shown a top level schematic of an SHG laser system with a frequency stabilized semiconductor seed laser in accordance with an illustrative embodiment. Components shown are frequency stabilized semiconductor seed laser 102, fiber amplifier 104, focusing optics 106, non-linear material structure 108, frequency filter 110, and output optics 112. The frequency stabilized semiconductor seed laser 102, producing a fundamental light (ω), has a gain region comprised of laser active material. The fundamental light may be, for example, infra-red (IR) light, however other frequencies may be produced as a fundamental light. The term “light” herein refers to electromagnetic radiation, whether or not in the visible frequency range. The fundamental light then leaves frequency stabilized semiconductor seed laser 102 and is amplified by fiber amplifier 104. The amplified fundamental light is then focused by focusing optics 106 into non-linear material structure 108, wherein a portion of the fundamental light is converted into a second harmonic generation (SHG) light, for example, a green or blue light.

Light path 150 is the path taken by a portion of the fundamental light (ω) generated by frequency stabilized semiconductor seed laser 102 to fiber amplifier 104. Light path 150 may be an optical fiber, a polarization maintaining optical fiber, and/or an optical connector or the like. Light path 151 represents the feedback circulation path taken by a second portion of the fundamental light (ω) produced by frequency stabilized semiconductor seed laser 102. Light path 152 is the path taken by the amplified fundamental light (ω) leaving fiber amplifier 104 and entering focusing optics 106. Light path 152 may be an optical fiber and/or a gap filled with a gas, for example, nitrogen, air, or the like.

Light path 154 is the path taken by the focused amplified fundamental light entering non-linear material 108. Light path 154 may be for instance a gap filled with a gas, such as for example, nitrogen, air, or the like. Light path 156 is the path the second harmonic frequency light, generated in non-linear material 108, plus the portion of the fundamental frequency light that is not converted into SHG light takes as it enters frequency filter 110. The fundamental frequency (ω) is filtered out. The second harmonic light (2ω) takes path 158 and is output from SHG laser system 100 through output optics 112.

Further, note that in accordance with the illustrative embodiments, SHG laser system 100 is a single-pass system. Frequency stabilized semiconductor seed laser may be an intra-cavity system with the only feedback to the frequency stabilized semiconductor seed laser 102 represented by path 151. Notice there is no feedback from the light path following non-linear structure 108 to frequency stabilized semiconductor seed laser 102. In other words, the fundamental light is circulated back into frequency stabilized semiconductor seed laser 102 only before the fundamental light enters into fiber amplifier 104.

Thus, the single-pass configuration is aptly named because the fundamental beam, in this example, IR, has a single opportunity to pass into the non-linear material configuration for generation into a second harmonic beam. Depending on the application, the remaining fundamental beam exiting the system may be filtered out by frequency filter 110 of the laser system output.

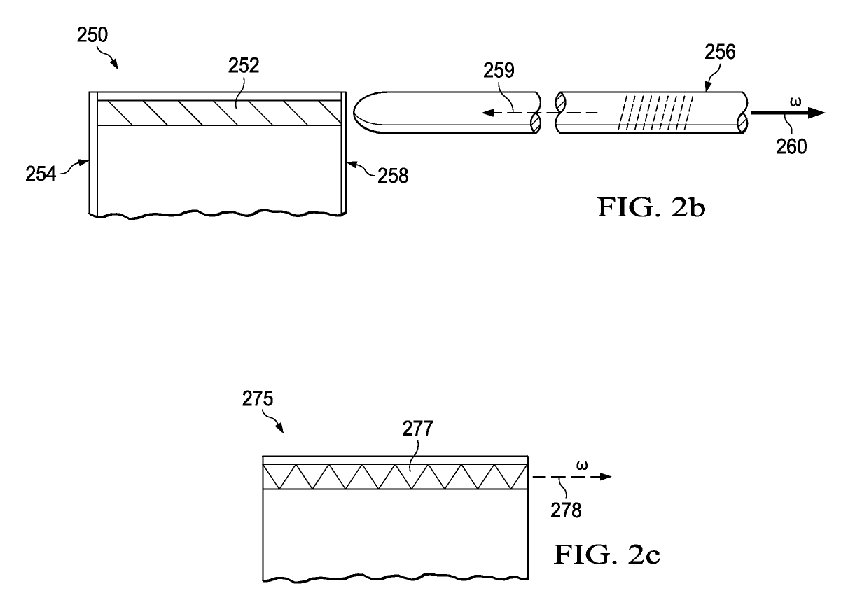

Frequency stabilized semiconductor seed laser 102 may be a distributed Bragg reflector (DBR) laser, a Fabry-Perot laser with a fiber Bragg grating, a distributed feedback (DFB) laser, or the like. FIG. 2 illustrates three examples of frequency stabilized semiconductor seed lasers.

As are other lasers, a frequency stabilized semiconductor seed laser is composed of an active laser medium, or gain medium, and a resonant optical cavity. The gain medium transfers external energy into the laser beam. The area of the laser in which this transfer occurs is called the gain region. It is a material of controlled purity, size, concentration, and shape, which amplifies the beam by the quantum mechanical process of stimulated emission. The gain region is pumped, or energized, by an external energy source. Examples of pump sources include electricity and light. The pump energy is absorbed by the laser medium, placing some of its particles into excited quantum states. When the number of particles in one excited state exceeds the number of particles in some lower-energy state, population inversion is achieved. In this condition, an optical beam passing through the gain region produces more stimulated emission than the stimulated absorption, so the beam is amplified. The light generated by stimulated emission is very similar to the input light in terms of wavelength, phase, and polarization. This gives laser light its characteristic coherence, and allows it to maintain the uniform polarization and wavelength established by the optical cavity design.

The optical cavity contains a coherent beam of light between reflective surfaces, for example, a distributed Bragg reflector, so that each photon passes through the gain region more than once before it is emitted from the output aperture or lost to diffraction or absorption. As light circulates through the cavity, passing through the gain region, if the amplification or gain in the medium is stronger than the cavity losses, the power of the circulating light may rise exponentially. The gain region will amplify any photons passing through it, regardless of direction; but only the photons aligned with the cavity manage to pass more than once through the medium and so have significant amplification.

Semiconductor lasers within the scope of the illustrative embodiments may be based upon one of four different types of materials, depending upon the wavelength region of interest. Three of the materials are III-V semiconductors, consisting of materials in columns III and V of the periodic table. Examples of column III atoms include aluminum (Al), gallium (Ga), indium (In), and thallium (Tl), and examples of column V atoms are nitrogen (N), phosphorus (P), arsenic (As), and antimony (Sb). Semiconductor lasers in the near infrared and extending into the visible may be based on GaAs/AlGaAs layers. Indium phosphide (InP) may be used to produce lasers in the 1.5 μm wavelength region with InP/InGaAlP layered materials. Gallium nitride (GaN) may be used for blue and ultraviolet lasers.

Other materials within the scope of the illustrative embodiments are based on II-VI compounds, consisting of materials in columns TI and VI of the periodic table. Examples of column II atoms are zinc (Zn) and cadmium (Cd). Examples of column VI atoms are sulfur (S), selenium (Se), and tellurium (Te). An example of II-VI compound is zinc selenide (ZnSe). Many more compounds may be used for semiconductor lasers, producing lasers of various wavelengths, and all of them are within the scope of the present invention.

FIG. 2a shows a side view of a distributed Bragg reflector (DBR) laser used in an illustrative embodiment as a frequency stabilized semiconductor seed laser, such as frequency stabilized semiconductor seed laser 102 of FIG. 1. DBR laser 200 has gain region 202, DBR structure 204 on one side, and mirror structure 206 on the opposing side, that act to set up the resonant condition for lasing. Light path 208 corresponds to light path 150 in FIG. 1. Light path 210 corresponds to light path 151 in FIG. 1.

DBR laser 200 has a DBR reflector 204 that is formed in the semiconductor material. Distributed Bragg reflector 204 may be a reflector that is formed from multiple layers of alternating materials with a varying refractive index, or by periodic variation of some characteristic (such as height) of a dielectric waveguide, resulting in periodic variation in the effective refractive index in the guide. Each layer boundary causes a partial reflection of an optical wave. For waves whose wavelength is close to four times the optical thickness of the layers, the many reflections combine with constructive interference, and the layers act as a high-quality reflector. Therefore, those of ordinary skill in the art will recognize that DBR laser 200 is a frequency stabilized semiconductor laser.

DBR laser 200 is formed on gallium arsenide (GaAs) substrate 212. Epitaxial layers consisting of aluminum gallium arsenide (AlGaAs) 214, indium gallium arsenide (InGaAs) forming the quantum well 216, another layer of aluminum gallium arsenide (AlGaAs) 218, and gallium arsenide (GaAs) 220 are formed on gallium arsenide (GaAs) substrate 212.

The relatively thin layer of indium gallium arsenide (InGaAs) 216 is termed the quantum well. A quantum well is a potential well that confines carriers, which were originally free to move in three dimensions, to two dimensions, forcing them to occupy a planar region. The effects of quantum confinement take place when the quantum well thickness becomes comparable at the de Broglie wavelength of the carriers, generally electrons and holes. The quantum well may be grown by molecular beam epitaxy or vapor deposition by controlling the layer thickness down to monolayers.

Turning now to FIG. 2b, another illustrative embodiment of an SHG laser uses a Fabry-Perot plus fiber Bragg grating configuration as the frequency stabilized semiconductor seed laser.

Fabry-Perot laser plus fiber Bragg grating (FP+FBG) 250 is a laser oscillator in which two mirrors 254 and 256 are separated by the laser medium in gain region 252. Gain region 252 may have a similar description to gain region 202 as discussed in FIG. 2a. Mirror 254 is a highly reflecting mirror that reflects fundamental light (ω) light through gain region 252. Fiber Bragg grating (FBG) 256 is the other reflective structure that forms a standing light wave allowing gain region 252 to lase. A Fabry-Perot laser is not, in itself, a frequency selective configuration. The frequency in FP+FBG system 250 is stabilized in fiber Bragg grating 256.

A fiber Bragg grating, such as fiber Bragg grating 256, may be a periodic or aperiodic perturbation of the effective refractive index in the core of an optical fiber. Typically, the perturbation is approximately periodic over a certain length, for example, a few millimeters or centimeters, and the period is of the order of hundreds of nanometers. The fiber Bragg grating may be, for example, a meter long with one or more periodic perturbation regions within. The reflection of light propagating along the fiber is in a narrow range of wavelengths, for which a Bragg condition is satisfied. This means that the wavenumber of the grating matches the difference of the wavenumbers of the incident and reflected waves. In other words, the complex amplitudes corresponding to reflected field contributions from different parts of the grating are all in phase, so that they can add up constructively. Other wavelengths are minimally affected by the Bragg grating. Therefore, those of ordinary skill in the art will recognize the FP+FBG system as a frequency stabilized semiconductor laser.

Gain region 252 may be, for example, about 750 μms and fiber Bragg grating 256 may be, for example, about 1 meter. Mirror structure 254 may be, for instance, the cleaved edge of gain region 252 with a high reflective coating or the like. Opposing side of gain region 252 may have an antireflective coating 258, enabling the fundamental frequency light (ω) to enter fiber Bragg grating 256. Fiber Bragg grating 256 provides feedback for gain region 256. Fiber Bragg grating 256 also allows a portion of fundamental frequency to exit the fiber Bragg grating 256 on path 260 and enter a fiber amplifier such as fiber amplifier 104 of FIG. 1. Light path 259 correlates to light path 151 in FIG. 1 and light path 260 correlates to light path 150 in FIG. 1.

FIG. 2c is an illustrative embodiment of a distributed feedback (DFB) frequency stabilized semiconductor seed laser. Distributed feedback laser 275 may be a laser wherein essentially the entire laser cavity consists of periodic structure 277. Periodic structure 277 may act as a distributed reflector in the wavelength range of laser action, and may contain a gain medium. Periodic structure 277 may be made with a phase shift in the middle. A distributed feedback laser may be thought of as two Bragg gratings with internal optical gain. Distributed feedback lasers in general are known by those of ordinary skill in the art and therefore will not be discussed in detail herein, except as the DFB laser relates to the SHG laser system as a frequency stabilized semiconductor seed laser.

Semiconductor DFB lasers can be built with an integrated grating structure, for example, a corrugated waveguide, which acts as periodic structure 277. DFB lasers may have a wide spectral range of at least between about 0.8 μm and 2.8 μm. Standard output powers are in the tens of milliwatts. The linewidth is typically in the hundred MHz range, and wavelength tuning is often possible over several nanometers. Distributed feedback laser 275 is a semiconductor laser. Light path 278 correlates to light path 150 in FIG. 1. Light path 151 of FIG. 1 correlates to the internal feedback in distributed feedback laser 275.

Frequency stabilized semiconductor seed lasers may be or may not be operated in the coherence collapse regime as referenced in U.S. patent application Ser. No. 11/763,248, incorporated herein by reference. Typically, lasers are developed and tuned to emit a narrow frequency of light with a portion of the laser light fed back into the gain region. Many observations and calculations of the effects that can occur in semiconductor lasers subjected to reflections external to the gain region have been made. Principally, five regimes of feedback effects in lasers have been defined.

The regimes are defined by the behavior of the frequency spectra of the laser subjected to different feedback power level ratios. Generally, these five regimes of operation are experimentally well defined, and the transitions between them may be easily identified. For example, refer to R. W. Tkach et al., “Regimes of Feedback Effects in 1.5-μm Distributed Feedback Lasers,” Journal of Lightwave Technology, vol. LT-4 (11), pp. 1655-1661, November 1986.

Regime I, the lowest level of feedback, shows a narrowing or broadening of the frequency emission line, depending on the phase of the feedback. The phase of the feedback is critical in Regime I. Any slight change in phase causes emission linewidth instability. Regime TI shows instabilities in emission linewidth, depending on the distance to the external reflector. The broadening, which is observed at the lowest levels for out of phase feedback, changes to an apparent splitting of the emission line, arising from rapid mode hopping. The magnitude of the splitting depends on the strength of the feedback and on the distance to the reflector.

Regime III is entered as the feedback is increased further. The emission linewidth in Regime III does not depend on the distance to the reflection; the mode hopping is suppressed, and the laser is observed to operate on a single narrow line. This regime may occupy only a small range of feedback power ratio; for example, from −45 dB to −39 dB, and, consequently, the laser remains sensitive to other reflections of comparable or greater magnitude.

Regime IV is at a feedback level that does not depend on the distance to the reflection and may occur for a distributed feedback laser, for example from −38 dB to −8 dB. The transition from Regime III to Regime IV may occur at higher feedback power ratios for higher laser powers. Regime IV is defined by satellite modes appearing separated from the main mode by the relaxation oscillation frequency. These satellite modes grow as the feedback power ratio increases, and the laser emission line may broaden to as much as 50 GHz with further feedback power. The transition between Regime IV and Regime V may occur at a lower feedback power ratio (lower than −8 dB) for higher laser power. Regime IV is termed “coherence collapse” because of the drastic reduction in the coherence length of the laser. Coherence length is the propagation distance from a coherent source to a point where an electromagnetic wave maintains a specified degree of coherence. Degree of coherence is the parameter that quantifies the quality of the interference. The effects within this regime are independent of the feedback phase. Due to the emission line broadening properties and smaller coherence length, lasers that operate in Regime IV are historically avoided or relegated to pump lasers. The transition between Regime IV and Regime V is at the feedback power ratio at which the emission line narrows.

Regime V is defined at the highest levels of feedback (typically greater than −10 dB) with a narrow linewidth emission observed. Typically, it is necessary to use an antireflection coat on the laser facet to reach this regime. In this regime, the laser operates as a long cavity laser with a short active region. If there is sufficient frequency selectivity in the cavity, the laser operates on a single longitudinal mode with narrow linewidth emission for all phases of the feedback.

Some laser applications may require a narrow linewidth emission, therefore, lasers have been typically operated in the feedback power ratio of Regime V or Regime III. Illustrative embodiments provide a system and method of operating an intra-cavity frequency stabilized semiconductor seed laser in the feedback power ratio of Regime IV. The broadened frequency emission of the gain region operating in the coherence collapse regime beneficially increases the power and stability of the fundamental frequency emission from the seed laser. Operating in the coherence collapse regime, the gain region produces an infrared light across broad frequency emission linewidth (in the range of 50 GHz).

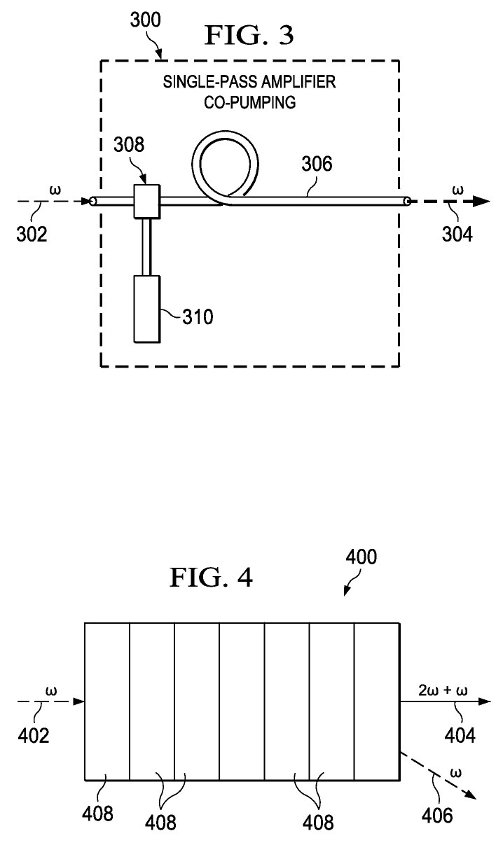

FIG. 3 shows an example of a fiber amplifier such as fiber amplifier 104 in FIG. 1. Fiber amplifier 300 amplifies the fundamental light (ω) received on light path 302 from frequency stabilized semiconductor seed laser (light path 150 in FIG. 1) and boosts the power of the fundamental frequency (ω).

Fiber amplifiers, such as fiber amplifier 300, are optical amplifiers based on employing optical fibers as gain media. The gain medium may be a fiber doped with a transition metal or a rare-earth ion such as erbium, neodymium, ytterbium, praseodymium, thulium, or the like. In general, a fiber amplifier amplifies light by pumping the active dopant in the fiber with light energy from at least one pump laser. The pump light propagates through the fiber core together with the signal to be amplified. Due to the possible small mode area and long length of an optical fiber, a high gain of tens of decibels can be achieved with a moderate pump power, and the gain efficiency can be very high. The high surface-to-volume ratio and the robust single-mode guidance also allow for very high output powers with diffraction-limited beam quality, particularly when double-clad fibers are used.

Fiber amplifier 300 shows a high-power, single-stage, Yb doped fiber amplifier as an example fiber amplifier. In this example, the input wavelength of light entering on path 302 is in the IR range at a power of about 100-500 mW. Light path 302 correlates to light path 150 in FIG. 1. In this example, double-clad Yb fiber 306 of between 12 and 20 m is used as an optical gain region. Pump combiner 308 combines the input from pump laser 310 and the fundamental frequency light (ω) from light path 302. Pump laser 310 may be a fiber-coupled diode laser. While the example given herein is a single-pass co-pumping fiber amplifier, other fiber amplifiers may be used, such as a single-pass counter-pumping fiber amplifier, a dual pump fiber amplifier, or the like. A single-pass co-pumping amplifier has a pump laser before the gain region of the fiber amplifier, with respect to the direction of seed light propagation. A single-pass counter-pumping amplifier has a pump laser after the gain region of the fiber amplifier, with respect to the direction of seed light propagation.

The output power from the example high-power single-stage Yb fiber amplifier may be in the range of 10 W. Light path 304 correlates to light path 152 in FIG. 1.

The frequency stabilized semiconductor seed laser, such as frequency stabilized semiconductor seed laser 102 in FIG. 1, provides the “template” frequency and phase so that the output of the fiber amplifier is the amplified (higher watt) frequency and phase of the frequency stabilized semiconductor seed laser.

Briefly turning back to FIG. 1, the output from fiber amplifier 104 (light path 152) is focusing optics 106 to optimize the amount of fundamental light (ω) converted to SHG light (2ω) in non-linear material structure 108. Non-linear material structure 108 may have an optimum focusing condition, such as a Boyd-Kleinman focusing condition or other focusing method may be used, which implements the desired focusing results. Focusing structure 106 in FIG. 1 focuses the incoming fundamental frequency light (ω) into the non-linear material structure 108 to generate the second harmonic beam (2ω).

Turning now to FIG. 4, an example of non-linear material structure such as non-linear material structure 108 in FIG. 1 is shown.

Crystal materials lacking inversion symmetry can exhibit a so-called χ⁽²⁾ nonlinearity and are termed non-linear material. Non-linear material may be used when light frequencies in the regions of interest are not practically achievable with fundamental laser light. Non-linear material uses optical nonlinearities to generate light with other wavelengths (frequencies). Frequency doubling is one such example of a nonlinear process. Frequency doubling occurs when an input (seed) light generates another light with twice the optical frequency and half the wavelength, in the medium. The seed light (ω) is delivered and the frequency-doubled (second-harmonic) light (2ω) is generated in the form of a light beam propagating in a similar direction.

Some examples of non-linear materials include lithium niobate (LiNbO₃) and lithium tantalate (LiTaO₃). Both materials are available in congruent and in stoichiometric form, with important differences concerning periodic poling and photorefractive effects. Lithium niobate and tantalate are the most often used materials in the context of periodic poling; the resulting materials are called PPLN (periodically poled lithium niobate) and PPLT, respectively, or PPSLN and PPSLT for the stoichiometric versions. Both have a relatively low damage threshold, but do not need to be operated at high intensities due to their high nonlinearity. The tendency for “photorefractive damage” strongly depends on the material composition, and it can be reduced with MgO doping and/or by using a stoichiometric composition. Therefore, PPMgLN may be employed.

Potassium niobate (KNbO₃) has a very high nonlinearity. Potassium titanyl phosphate (KTP, KTiOPO₄) also KTA (KTiOAsO₄), RTP (RbTiOPO₄) and RTA (RbTiAsPO₄) are other examples. These materials tend to have relatively high nonlinearities and are suitable for periodic poling. Potassium dihydrogen phosphate (KDP, KH₂PO₄) and potassium dideuterium phosphate (KD*P, KD₂PO₄) are also common. K₂Al₂B₂O₇=KAB, LBO, BBO, CLBO, CBO and other borate crystals may be suitable.

Frequency doubling to the visible range may require a high poling quality for small poling periods. Periodic poling involves a process that generates a periodic reversal of the domain orientation in a nonlinear crystal, so that the sign of the nonlinear coefficient also changes. The poling period (the period of the domain orientation pattern) determines the wavelengths for which certain nonlinear processes can be quasi-phase-matched.

FIG. 4 illustrates a standard non-linear material structure. An amplified seed light is focused into a crystal of PPMgSLN or the like. Light path 402 correlates to light path 154 in FIG. 1. The seed light is focused and travels through non-linear crystal 400, thereby generating second harmonic light (2ω). Some of the fundamental frequency light (ω) may be reflected out of the system (represented by light path 406) and another portion of fundamental frequency light may be propagated along light path 404 with the 2ω light. Light path 404 correlates to light path 156 in FIG. 1. In this example, the non-linear material structure 400 is a periodically poled (as indicated by 408) non-linear crystal. The scope of the illustrated embodiments includes other non-linear materials and more complex non-linear structures.

In the case of a seed laser operating in the coherence collapse regime, the broad linewidth of the fundamental frequency focused into the non-linear material structure may have a plurality of frequencies that are mode matched to the nonlinear material structure. The nonlinear material structure then doubles a portion of each of the accepted modes of the broad frequency fundamental light and emits a plurality of second harmonic frequencies of each of the accepted modes of the fundamental light. In this example, the frequencies may be blue or green visible light.

The 2ω+ω output, such as the output on light path 158 in FIG. 1, is then filtered in the system frequency filter such as frequency filter 110 in FIG. 1. Frequency filter 110 is a harmonic separator and thus separates the ω from the 2ω light.

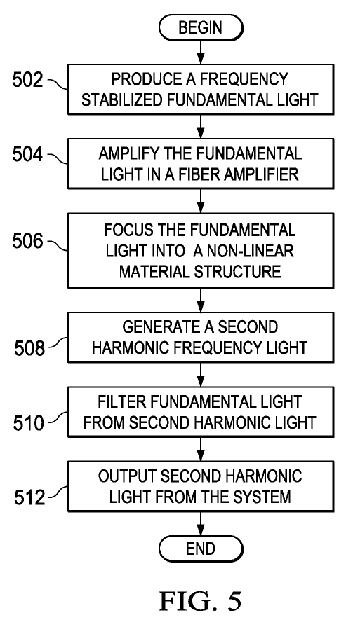

Turning to FIG. 5, a flow chart illustrating the process steps for a method for providing second harmonic generation (SHG) light in the visible frequency range at greater than 0.5 watts is shown. The process begins by producing a frequency stabilized fundamental light (step 502). The fundamental light may be produced in a seed layer such as a DBR, DFB, FP+FBG, or the like semiconductor laser. Next, the fundamental light is amplified in a fiber amplifier (step 504). The fiber amplifier may be a single-pass co-pumping, a single-pass counter-pumping, a dual pump, or the like.

The amplified fundamental light is then focused through a lens into non-linear material structure (step 506). The second harmonic light is generated in the non-linear material structure (step 508). A filter configuration filters out the non second harmonic light (step 510) and the process ends by outputting the second harmonic light from the system (step 512).

Although the illustrative embodiment and its advantages have been described in detail, it should be understood that various changes, substitutions, and alterations can be made herein without departing from the spirit and scope of the invention as defined by the appended claims. For example, light frequencies and power may be varied while remaining within the scope of the present invention.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A single-pass system for producing second harmonic generation (SHG) light comprising:
a frequency stabilized seed laser, wherein the frequency stabilized seed laser is a semiconductor distributed Bragg reflector (DBR) laser or a semiconductor Fabry-Perot laser plus a fiber Bragg grating (FP+FBG);
a fiber amplifier receiving a first frequency light from the frequency stabilized semiconductor seed laser;
a non-linear material generating a second frequency light;
a focusing optic configuration receiving the first frequency light from the fiber amplifier and focusing the first frequency light into the non-linear material;
a harmonic separator filtering the first frequency light from the second frequency light; and
an output optical structure outputting the second frequency light from the single-pass system.

2. (canceled)

3. The system of claim 1 further comprising the frequency stabilized semiconductor seed laser operating in the coherence collapse regime.

4. The system of claim 1, wherein the non-linear material is selected from a group of PPKTP, PPMgLN, PPLN, and PPSLT.

5. The system of claim 1, wherein the second frequency light is in the visible light range.

6. The system of claim 1 further comprising the single-pass system outputting a second frequency light at greater than 0.5 watts.

7. The system of claim 1 further comprising the single-pass system outputting a second frequency light at greater than 3.0 watts.

8. The system of claim 1 further comprising a polarization maintaining (PM) optical fiber.

9. A single-pass method for producing a second harmonic generation (SHG) light comprising:
producing a first frequency light in a frequency stabilized semiconductor seed laser comprising a semiconductor distributed Bragg reflector (DBR) laser, or a semiconductor Fabry-Perot laser plus a fiber Bragg grating (FP+FBG);
amplifying the first frequency light in a fiber amplifier;
focusing the first frequency light into a non-linear material;
generating a second frequency light in the non-linear material;
separating the first frequency light from the second frequency light; and
outputting the second frequency light.

10. (canceled)

11. The method of claim 9 further comprising operating the frequency stabilized semiconductor seed laser in the coherence collapse regime.

12. The method of claim 9 further comprising selecting the non-linear material from a group of PPKTP, PPMgLN, PPLN, and PPSLT.

13. The method of claim 9 further comprising outputting the second frequency light in a visible light range.

14. The method of claim 9 further comprising outputting the second frequency light at greater than 0.5 watts in a single pass.

15. The method of claim 14 further comprising outputting the second frequency light at greater than 3.0 watts in a single pass.

16. The method of claim 9 further comprising polarization maintaining (PM) optical fiber.

17. A single-pass method for producing a second harmonic generation (SHG) light comprising:
operating a frequency stabilized semiconductor distributed Bragg reflector (DBR) laser or a semiconductor Fabry-Perot laser plus a fiber Bragg grating (FP+FBG) in the coherence collapse regime;
producing a first frequency light in the frequency stabilized seed laser;
amplifying the first frequency light in a fiber amplifier;
focusing the first frequency light into a non-linear crystal;
generating a second frequency light in the non-linear crystal;
separating the first frequency light from the second frequency light; and
outputting a single-pass second frequency.

18. The method of claim 17 further comprising selecting a non-linear material from a group comprising PPKTP, PPMgLN, PPLN, and PPSLT.

19. The method of claim 17 further comprising outputting a single-pass second frequency in the visible light range.

20. The method of claim 17 further comprising outputting a single-pass second frequency at greater than 0.5 watts.
